(19) United States
(12) Patent Application Publication
(10) Pub. No.: US 2020/0042580 A1
(43) Pub. Date: Feb. 6, 2020

(54) SYSTEMS AND METHODS FOR ENHANCING AND REFINING KNOWLEDGE REPRESENTATIONS OF LARGE DOCUMENT CORPORA

(71) Applicant: amplified ai, a Delaware corp., Fairfax Station, VA (US)

(72) Inventors: Samuel DAVIS, Fairfax Station, VA (US); Christopher GRAINGER, Florida, FL (US); Yasuyuki OIKAWA, Tokyo (JP)

(73) Assignee: amplified ai, a Delaware corp., Fairfax Station, VA (US)

(21) Appl. No.: 16/293,082

(22) Filed: Mar. 5, 2019

Related U.S. Application Data
(60) Provisional application No. 62/638,656, filed on Mar. 5, 2018.

(51) Int. Cl. G06F 17/24; G06F 16/93; G06N 20/00

(52) U.S. Cl. CPC G06F 17/24; G06N 20/00; G06F 16/93

(57) ABSTRACT

The invention enhances a user's ability to locate pertinent information in a sea of less relevant information. The invention enhances known artificial intelligence techniques by allowing a user to characterize select portions of information through a user interface which mimics manual workflows but has the added value of learning from those actions to improves system-wide performance.

### CROSS-REFERENCE TO RELATED APPLICATIONS

This application claims the benefit of priority to U.S. Application No. 62/638,656, filed Mar. 5, 2018, in the United States Patent and Trademark Office. All disclosures of the document named above are incorporated herein by reference.

### SUMMARY OF THE INVENTION

The invention enhances a user's ability to locate pertinent information in a sea of less relevant information. The invention enhances known artificial intelligence techniques by allowing a user to select portions of information and add additional information tags through a user interface which mimics manual workflows but has the added value of learning from those actions to improves system-wide performance, task-specific performance, and automatically produce work product such as reports.

In one embodiment the invention can be applied to the problem of identifying more pertinent text documents, for example identifying a selected set of technical descriptions related to a target technical description. The target technical description might be a granted patent or published patent application, scientific and research papers, product manuals, technical documentation, internal memos or notes, conference presentations and proceedings, news, published regulatory information including legal and court proceedings, government publications and finance or tax filings or any other text based document that contains business, financial, product, or technical information that have been embedded in the system. Reference documents may be similar in content to the target document. The basic purpose of the invention is to assist a user in selecting the reference document or documents which satisfy a particular goal of the user, i.e., for example to find an anticipation in the reference documents of a technical description in the target document.

This invention embeds these documents (target and reference) into multi-dimensional vector space. Although the specific means of embedding can be arbitrarily chosen the choice is driven empirically by the problem space. Embedding uses a combination of standard NLP, machine learning, and deep learning techniques such as word2vec, doc2vec, recurrent neural networks, convolutional neural networks, etc. For example, Facebook Research has open sourced a library that creates embeddings called FastText https://research.fb.com/fasttext/.

Once the target technical description and other documents are embedded into vector space it is then possible to measure the distance between any given documents. For example, one technique that can be used is the cosine distance of nearest neighbors although the specific choice of how to measure is not important.

The embeddings are improved by a system which prompts users to make various choices about the similarity between the other documents in comparison to the target technical description. This step can be done after the initial embeddings are created by the artificial intelligence or as part of the creation process. In both cases the embeddings are improved so that the process of interpreting text data to answer domain-specific questions also improves. Domain specific examples may be finding technical relevancy, determining novelty through existence of prior art, grouping patents by technology, etc. The system provides several mechanisms for improving the embeddings. These include applying a relevancy tag which allows for a document to be tagged as relevant or not relevant to the target technical description. In addition to the simple relevant or not relevant tag, additional tags may indicate possibly relevant and not relevant. Additionally, the embeddings may be improved by providing a highlighting feature which allows for one or more passages of text in the target technical description to be highlighted and tagged to one or more passages in each document, so that the embedding may be improved by learning specifically which passages determined the connection thereby going from understanding the entire document to a more granular understanding. Furthermore, the embeddings may be improved by boosting of specific text phrases through an input feature allowing for an additional tag or set of tags to be added to the target technical description that boosts embeddings for that additional tag or set of tags. This recalibrates all remaining documents so that those with more similarity to the embeddings of the additional tag or set of tags are prioritized and shown to the user first. Another embedding improvement feature is provided where technical tags can be applied in order to better interpret a vector representation of a document as belonging to said technical tag which infers a linguistic connection between that document and the technical tag. This feature includes accept/reject mechanisms for suggested tags and custom add/remove features for creating new tags. These both improve the embedding creation and modification process. Each of these embedding improvement features, used in isolation or in aggregate, provides an improved mechanism for extrapolating the relationships between documents from multiple perspectives and at varying degrees of detail, leading to an improved performance of the system's linguistic understanding and therefore provide greater value to users.

In one embodiment the invention includes:
a storage module for storing a representation of plural documents:
a vector embedding module, coupled to said storage module for processing document representations from said storage module to produce embedded documents, each embedded document represented by a multi-dimensional vector and then storing multi-dimensional vectors representing said embedded documents in said storage module;
a feedback module for altering the embedded documents in response to user actions,
an extractor module coupled to said storage module for retrieving representations of selected documents from said storage module;
a user interface providing an input to the feedback module which allows the user to enhance representations of documents with additional information to mark selected document and forward the marked representations to the vector embedding module wherein the user's input affects the representation of documents retrieved by the extractor module.

### BRIEF DESCRIPTION OF THE DRAWINGS

The invention will now be further described in the following portions of this specification when taken in conjunction with the attached drawings in which:

FIG. 1 is a block diagram showing the major components of the invention;

FIG. 2 is a block diagram of the Learning Engine 20 component of FIG. 1, and

FIG. 3 is useful in describing the data flow among the components of FIG. 2.

### DESCRIPTION OF PREFERRED EMBODIMENTS

The invention includes a database trained and updated by a neural network and connected to a web application which can transmit information to users and receive user information and actions back. The invention is embodied in servers by computer programs and data and used by users with web browsers.

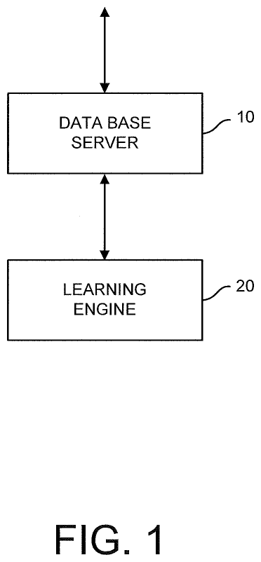

As shown in FIG. 1 a database server 10 contains and supports a corpus of document data. The database server 10 regularly updates the document data. The document data includes texts, figures, photographs, tables, handwritings, video, and any other forms of contents. The document data includes meta data associating each document, e.g. authors, tags, dates, indices, pages, paragraph number, etc.

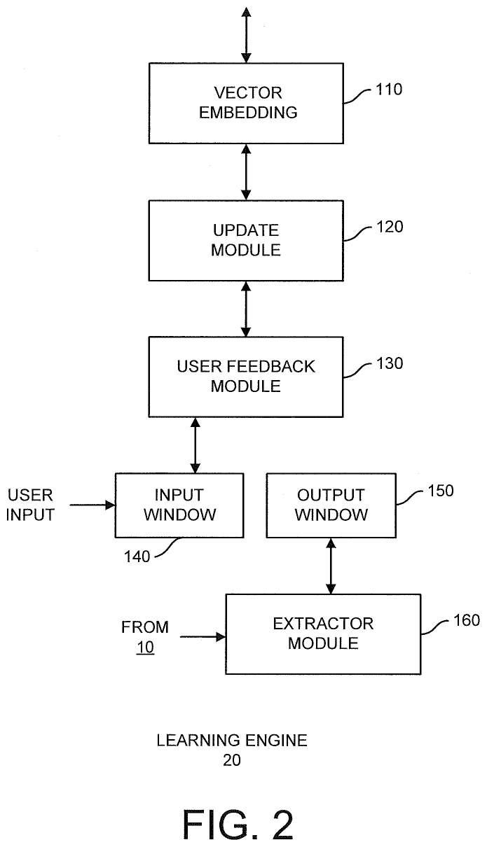

FIG. 1 also shows the learning engine 20. The learning engine 20 contains (as is shown in FIG. 2) a vector embedding module 110, an update module 120, an extractor module 160, a user feedback module 130, and a user interface including input window 140 and output window 150. The vector embedding module 110 is responsible for learning the best vector representation of document-based data in the corpus. The way to produce the vector representation is empirical to the problem space.

### Description of Vector Embeddings

The particular way the embedded documents are created by the vector embedding module 110 is empirical to the problem set but otherwise arbitrary. For example, a vector representation of text can easily be created through well-known methods including but not limited to word2vec, doc2vec, and TFIDF. The embedded documents themselves may also have variation and could include one-hot vectors (also known as discrete embeddings) or probabilistic embeddings. The fundamental concept behind why these approaches work is the theory of distributional semantics. The embeddings are represented in hyper-dimensional space. Since a human can't visualize beyond 3 dimensions there are techniques to reduce the dimensions down from let's say 100 to 3 or 2. Then you can display data in a way that still relates to the hyper-dimension space but can be viewed by a human.

### Description of Updating Module

Update module (UM) 120 updates embedded documents with information provided in part by the user feedback module 130. The particular way the embedded documents are updated is empirical to the problem set but otherwise arbitrary. For example, a vector representation of text can easily be updated through well-known methods including but not limited to auto-encoders, RNNs, siamese networks, doc2vec, word2vec, Glove, topic models, PCA, tf-idf, or any arbitrary task empirically chosen that creates an intermediate step (ex. asking users to predict assignees). The embedded documents themselves may also have variation and could include one-hot vectors (also known as discrete embeddings) or probabilistic embeddings. The fundamental concept behind why these approaches work is the theory of distributional semantics. In one embodiment the updating of the embedded documents is based on user input.

### Description of Extractor Module

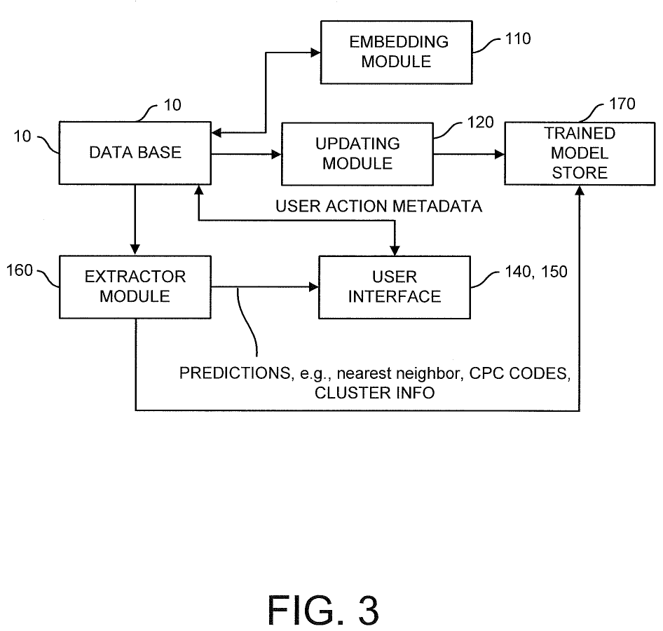

The extractor module (EM) 160 extracts information. The particular way information is extracted from the embedded documents depends on the required user input and desired output. Although the method may be chosen empirically the choice is otherwise arbitrary. Typical approaches are generally captured in the field of neural information retrieval. For example, similarity may be retrieved through a nearest neighbor calculation where distance can be defined as cosine distance, euclidean distance, or any other suitable mathematical distance measure. Another example is to use dimensionality reduction techniques (ex. 50D to 3D) such as PCA and t-sne to easily visualize high-dimensional space so that the user can select results of interest. The extractor module provides output information to the output window 150 and/or the trained model store 170 (FIG. 3)

### Description of User Feedback Module

The user feedback module 130 is responsible for collecting user feedback in the form of document tags, relevancy marking, and highlighting sections of text; and communicating that to the UM 120 and the EM 110 in order to improve the embeddings and extraction. This operation optimizes the overall system as well as the specific task the user is working on. Software features are deliberately chosen to collect user feedback that can be used by the updating module 120 to improve the embedded document representations. Specifically, the features include:
a) Tagging an embedded document as relevant or not relevant. This is positive and negative feedback on document-level similarity specific to each use case. For example, similarity may be defined differently in an invalidity search looking at a patent-to-patent comparison as it is in a novelty search looking at invention-to-patent. The same applies for clearance or infringement searching which is product-to-patent. Both the user-created similarity tag and the context of the action (i.e. invalidity search) are collected. In addition to the relevant/not relevant tags, users also have access to possibly relevant tags and not relevant tags.
b) Highlighting of sections of text or figures in a target document called a “target section” or “target feature” or product section” or “product feature” or “feature section” or “subject feature” or “invention feature”. The extractor module 160 uses specific text or figures to further refine the search and surface relevant documents to the user. This is specific to optimizing results for the user in the particular project they are working on and typically is done in real-time. This optimization is achieved through returning additional results that are more similar to those with the highlighted sections.
c) Highlighting of sections of text or figures (based on user input via the input window 140) in a result document called a “relevant section” or “relevant feature”. The extractor module 160 uses specific text or figures to further refine the search and surface relevant documents to the user. This is specific to optimizing results for the user in the particular project they are working on and typically is done in real-time.
d) A target section and relevant section can be linked to each other in order to establish relevance. For example, a figure in the target may be linked to a passage of text in one of the reference documents. This can be shown through matching the color of the highlighting, labelling each section in a corresponding way (such as target section 1 and relevant section 1), or any other method useful to the user. These linkages are sent to the updating module 120 which generalizes the learnings across the network of use cases, data, and users to improve the underlying embeddings and better predict linkages in future cases. These updates can be run manually or automatically at any given time which may be regular or intermittent.
e) Any document in the database may be tagged with additional information including but not limited to a product, technology covered, related research papers, related authors, related industries, related company(s), related products or trademarks and brand names, related benefits of technology, related macro level system components (e.g., engines, brakes, steering), related additional classifications (e.g., a Japanese F-Term patent classification or Standard Industrial Classification code tagged to a US patent, etc). This information can be used by the extractor module to more quickly and accurately locate relevant information for a user. For example, finding all documents related to a particular technology, product, or department. This is also sent to the updating module to improve embedded documents.
f) The user feedback module includes the input window 140 and output window 150. The information used in the functions a) through e) are provided by the user via the input window 140. Another interface is the output window 150. The output window 150 displays the search result to the user. The search result is a list of documents sorted by similarity to the input target document. The similarity is defined by the extractor module 160. In addition, the users can sort the results by their preferred criteria. The user can expand any document to review in detail. The target document may also be opened to review in detail. A document may be saved for analysis (marked as relevant) or removed from the list (marked as not relevant).

FIG. 3 is a flow diagram showing the flow of information between modules of the learning engine 20 and the database 10. The database 10 provides document information to the embedding module 110 and the embedding module 110 returns a vector representation of the document to the database 10. The extractor module 160 accepts document data (vector representations) from the database 10 and selects nearest neighbor documents to the trained model store 170 (which is part of the database 10) and to the user interface, particularly the output window 150 for viewing by the user. This may include predictions, cpc codes and cluster information. The user interface, particularly the input window 140, provides user input to the database 10 which is useful in updating in the updating module 120.

In use the data base stores a corpus of documents among which the user desires to locate one or more documents which are similar to a target document. In one application the target document may be an invention disclosure and the corpus includes documents which represent potential prior art to the invention disclosure. In an additional application, the target document may be a granted patent and the corpus includes documents which represent potential invalidating prior art to that granted patent. In an additional application, the target document may be a product description, and the corpus includes documents which represent potential freedom to operate or clearance barriers to selling, making or using that product. In an additional application, the target document may be a description of research, and the corpus includes documents which represent potential related solutions to that technical problem. In an additional application, the target document may be a granted patent or published patent application, or multiple patents or published applications, or other disclosures, and the corpus includes documents which represent nearest neighbor patents or products or business or industry information that is useful in licensing or understanding the landscape of related competition, partners, customers and their strengths weaknesses, threats and opportunities to that target. In another application the target document is a new legal contract, and the corpus includes similar additional contracts. i.e., prior legal contacts. In another application that target document is a product specification and the corpus of documents is other specifications or documents related to other specifications. The target document is added to the corpus and all documents are converted to a vector representation via the embedding module. An additional feature allows user input to the target document for providing additional information by highlighting important passages of text and, using a different highlighting to highlight unimportant passages. The extractor module then extracts the closest neighbor documents in the corpus to the target document. The user highlighting will enhance the “closeness” of documents which have parallels to the important highlighted target passages and also enhance the closeness of documents of the corpus which do not exhibit parallels to the unimportant passages of the target document.

1-6. (canceled)

7. A method for assisting in document selection, comprising the steps of:
creating a multi-dimensional vector representation of a target technical description,
selecting one or more documents from a data base server by measuring the distances between the target technical description and documents stored in the data base server in multi-dimensional vector space to provide the one or more documents to a user interface, and
in response to a user input to the user interface, refining selection result provided to the user interface.

8. The method of claim 7, wherein said refining includes modifying the vector representation.

9. The method of claim 7, wherein said user input includes a tag applied to a document displayed on the user interface.

10. The method of claim 9, wherein said tag includes a relevancy tag, a technical tag or a user created tag.

11. The method of claim 7, wherein said user input includes a section of the target technical description.

12. The method of claim 7, wherein said user input includes linkage between a section of the target technical description and a section of a document provided to the user interface.

13. The method of claim 7, the distance is defined differently depending on a context of the document selection.

14. The method of claim 7, the target technical description includes a granted patent, a published patent application, an invention disclosure or scientific or a research paper.

15. The method of claim 10, the relevancy tag includes a relevant tag, a not-relevant tag, and a probably relevant tag.

16. A system for assisting in document selection, which:
creates a multi-dimensional vector representation of a target technical description,
selects one or more documents from a data base server by measuring the distances between the target technical description and documents stored in the data base server in multi-dimensional vector space to provide the one or more documents to a user interface, and
in response to a user input to the user interface, refines selection result provided to the user interface.
